(19) United States
(12) Patent Application Publication
(10) Pub. No.: US 2014/0304000 A1
(43) Pub. Date: Oct. 9, 2014

(54) DIAGNOSIS-AND-TREATMENT-RECORD MANAGEMENT SYSTEM, DIAGNOSIS-AND-TREATMENT-RECORD MANAGEMENT METHOD, AND NON-TRANSITORY COMPUTER-READABLE MEDIUM

(71) Applicant: FUJI XEROX CO., LTD., Tokyo (JP)

(72) Inventor: Daigo AIZAWA, Kanagawa (JP)

(73) Assignee: FUJI XEROX CO., LTD., Tokyo (JP)

(21) Appl. No.: 14/063,697

(22) Filed: Oct. 25, 2013

(30) Foreign Application Priority Data
Apr. 5, 2013 (JP) 2013-079357

(51) Int. Cl. G06F 19/00

(52) U.S. Cl. CPC G06F 19/322
USPC 705/3

(57) ABSTRACT

A diagnosis-and-treatment-record management system includes a diagnosis-and-treatment-information memory, a disease-information memory, a compression unit, and a decompression unit. The diagnosis-and-treatment-information memory stores one or more records. In each of the records, patient identification information and diagnosis and treatment details are recorded. The disease-information memory stores information indicating at least one of a recurrence interval and a recurrence time period for a recurrent disease. The compression unit compresses information recorded in, among the records, a record the use of which has been completed and in which diagnosis and treatment details for a recurrent disease are recorded. Since a reference time at which treatment for the record for which information has been compressed was completed, before at least one of the recurrence interval and the recurrence time period has elapsed, the decompression unit decompresses the compressed information for the record.

### CROSS-REFERENCE TO RELATED APPLICATIONS

This application is based on and claims priority under 35 USC 119 from Japanese Patent Application No. 2013-079357 filed Apr. 5, 2013.

### BACKGROUND

1. Technical Field

The present invention relates to a diagnosis-and-treatment-record management system, a diagnosis-and-treatment-record management method, and a non-transitory computer-readable medium.

2. Summary

According to an aspect of the invention, there is provided a diagnosis-and-treatment-record management system including a diagnosis-and-treatment-information memory, a disease-information memory, a compression unit, and a decompression unit. The diagnosis-and-treatment-information memory stores one or more records. Each of the records is a record in which patient identification information by which a patient is identified and diagnosis and treatment details for a disease of the patient are recorded. The disease-information memory stores information indicating at least one of a recurrence interval and a recurrence time period for a recurrent disease. The recurrent disease recurs at the recurrence intervals, and the recurrent disease recurs for the recurrence time period. The compression unit compresses information recorded in, among the records stored in the diagnosis-and-treatment-information memory, a record the use of which for consultation has been at least temporarily completed and in which diagnosis and treatment details for a recurrent disease are recorded. Since a reference time at which treatment for the disease associated with the diagnosis details recorded in the record for which information recorded therein has been compressed by the compression unit was completed, before at least one of the recurrence interval and the recurrence time period which are stored for the disease in the disease-information memory has elapsed, the decompression unit decompresses the compressed information for the record.

### BRIEF DESCRIPTION OF THE DRAWINGS

An exemplary embodiment of the present invention will be described in detail based on the following figures, wherein:

FIG. 1 is a functional block diagram of a diagnosis-and-treatment-record management apparatus according to a present exemplary embodiment;

FIG. 2 is a diagram illustrating an example of a diagnosis-and-treatment-record table;

FIG. 3 is a diagram illustrating an example of a compressed-information table;

FIG. 4 is a diagram illustrating an example of a disease-information table;

FIG. 5 is a diagram illustrating an example of a hospital-attendance-record table;

FIG. 6 is a flowchart of a process of compressing or removing a record;

FIG. 7 is a flowchart of a process of decompressing a record; and

FIG. 8 is a flowchart of a process of analyzing recurrence of a disease.

### DETAILED DESCRIPTION

Hereinafter, an exemplary embodiment of the present invention will be described with reference to the drawings.

### 1. Description of Functions of Diagnosis-and-Treatment-Record Management Apparatus 10

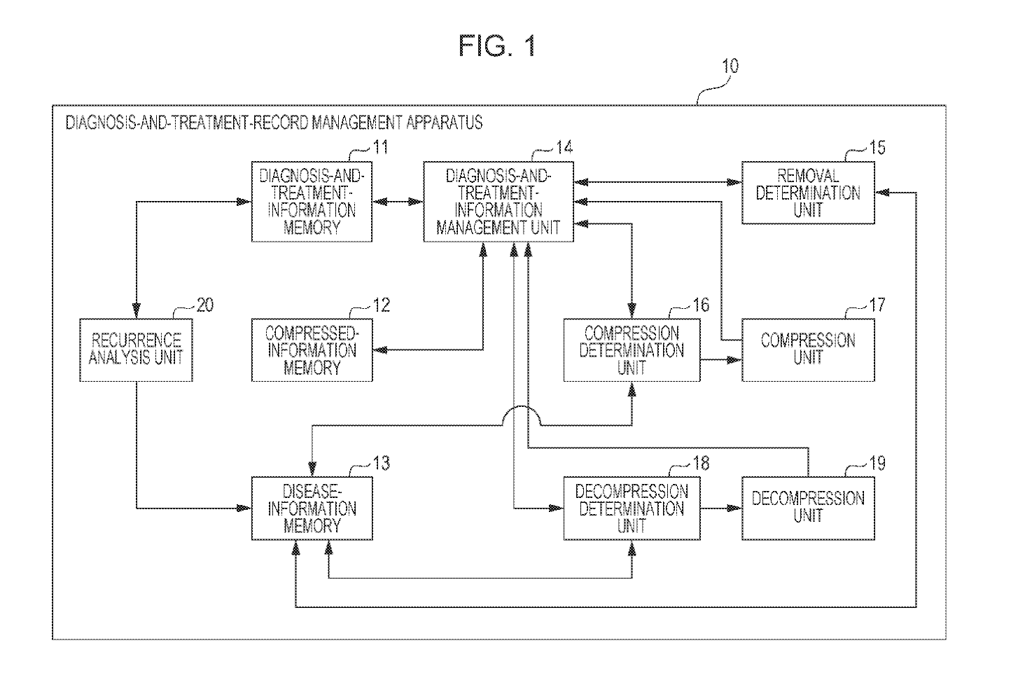

FIG. 1 is a functional block diagram of a diagnosis-and-treatment-record management apparatus 10 according to the present exemplary embodiment. As illustrated in FIG. 1, the diagnosis-and-treatment-record management apparatus 10 includes a diagnosis-and-treatment-information memory 11, a compressed-information memory 12, a disease-information memory 13, a diagnosis-and-treatment-information management unit 14, a removal determination unit 15, a compression determination unit 16, a compression unit 17, a decompression determination unit 18, a decompression unit 19, and a recurrence analysis unit 20.

Regarding functions of the above-mentioned individual units included in the diagnosis-and-treatment-record management apparatus 10, a computer that includes a control unit such as a central processing unit (CPU), a memory, an input/output unit which transmits/receives data to/from an external device, and so forth reads and executes a program stored on a computer-readable information storage medium, whereby the functions may be realized. Note that the program may be supplied, using an information storage medium such as an optical disk, a magnetic disk, a magnetic tape, an optical-magnetic disk, or a flash memory, to the diagnosis-and-treatment-record management apparatus 10 that is a computer. Alternatively, the program may be supplied to the diagnosis-and-treatment-record management apparatus 10 via a data communication network such as the Internet.

The diagnosis-and-treatment-information memory 11 is a database in which a diagnosis-and-treatment-record table including one or more records is stored, and, in each of the records, diagnosis and treatment details for each patient are recorded.

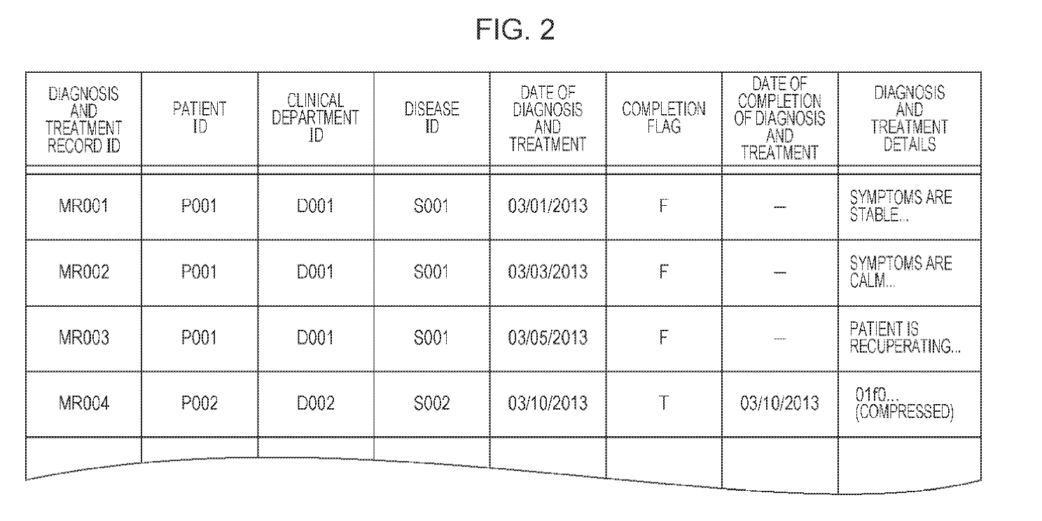

FIG. 2 illustrates an example of the diagnosis-and-treatment-record table stored in the diagnosis-and-treatment-information memory 11. As illustrated in FIG. 2, in the diagnosis-and-treatment-record table, the above-mentioned records are recorded. In each of the records, information is stored. The information indicates the following: a diagnosis and treatment record ID by which one record that is a diagnosis and treatment record is identified; a patient ID by which a patient is identified; a clinical department ID by which a clinical department related to consultation of the patient is identified; a disease ID by which a disease that the patient has contracted is identified; a date of diagnosis and treatment that is a date on which diagnosis and treatment was performed; a completion flag indicating whether or not diagnosis and treatment for the disease of the patient has been completed; a date of completion of diagnosis and treatment that is a date on which diagnosis and treatment was completed; and diagnosis and treatment details that include a text in which diagnosis and treatment details are described. In each of the records, the diagnosis and treatment record ID, the patient ID, the clinical department ID, the disease ID, the date of diagnosis and treatment, the completion flag, the date of completion of diagnosis and treatment, and the diagnosis and treatment details are associated with one another. Here, each of the records recorded in the diagnosis-and-treatment-record table includes a record in which data regarding at least diagnosis and treatment details is compressed.

The compressed-information memory 12 is a database in which information concerning a compressed and recorded record among the records included in the diagnosis-and-treatment-record table stored in the diagnosis-and-treatment-information memory 11 is stored.

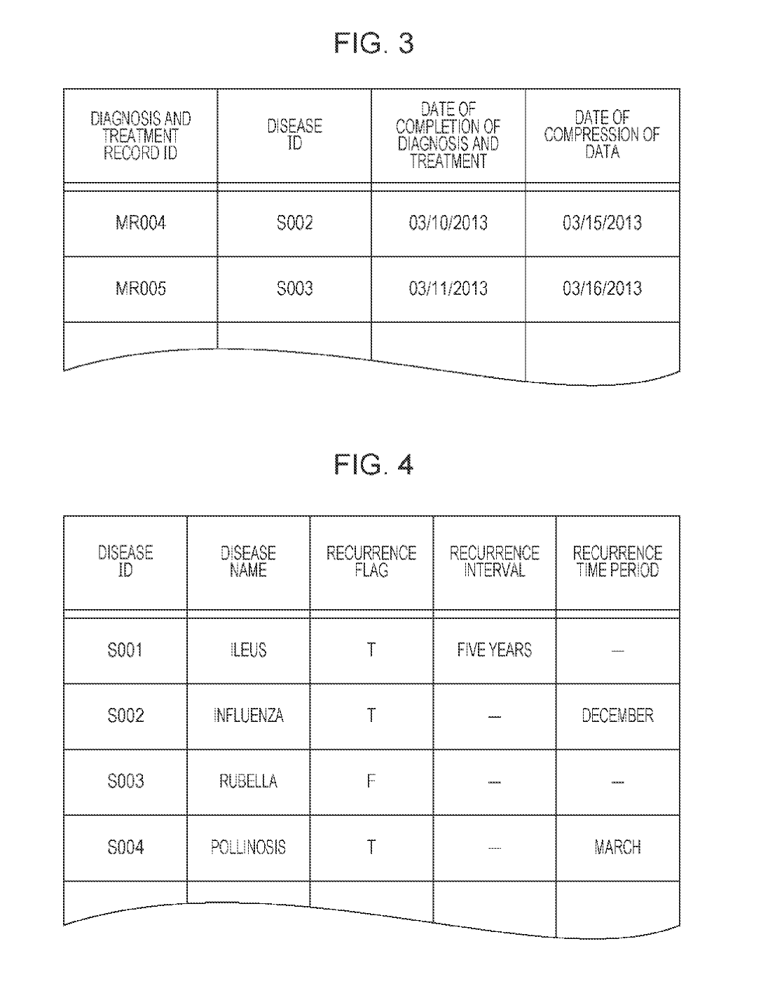

FIG. 3 illustrates an example of a compressed-information table stored in the compressed-information memory 12. As illustrated in FIG. 3, in the compressed-information table, records are recorded. In each of the records, information is stored. The information indicates the following: the diagnosis and treatment record ID by which a compressed record is identified; the disease ID included in the compressed record; a date of completion of diagnosis and treatment that is a date on which diagnosis and treatment for the disease recorded in the compressed record was completed; and a date of compression of data that is a date on which data of the record was compressed. In each of the records, the diagnosis and treatment record ID, the disease ID, the date of completion of diagnosis and treatment, and the date of compression of data are associated with one another.

The disease-information memory 13 is a database in which a disease-information table including one or more records is stored. In each of the records, information concerning each disease is recorded.

FIG. 4 illustrates an example of the disease-information table stored in the disease-information memory 13. As illustrated in FIG. 4, in the disease-information table, the above-mentioned records are recorded. In each of the records, information is stored. The information indicates the following: the disease ID by which a disease is identified; the name of the disease; a recurrence flag indicating whether or not the disease is a recurrent disease; a recurrence interval, the disease recurring at the recurrence intervals; and a recurrence time period for which the disease recurs (a disease development season in which patients develop the disease). In each of the records, the disease ID, the name of the disease, the recurrence flag, the recurrence interval, and the recurrence time period are associated with one another. For example, in the case where the disease is a recurrent disease, T (true) may be stored as the recurrence flag, and, in the case where the disease is not a recurrent disease, F (false) may be stored as the recurrence flag. Furthermore, only in the case where the recurrence flag is T (true), information indicating at least one of the recurrence interval and the recurrence time period is stored.

The diagnosis-and-treatment-information management unit 14 manages information that is stored in each of the diagnosis-and-treatment-information memory 11 and the compressed-information memory 12. For example, among the records recorded in the diagnosis-and-treatment-record table, in the case of a record that has been determined by the removal determination unit 15, which is described below, to be a record to be removed, the diagnosis-and-treatment-information management unit 14 removes the record. In the case of a record that has been determined by the compression determination unit 16, which is described below, to be a record to be compressed, the diagnosis-and-treatment-information management unit 14 updates the record to a record (a compressed record) obtained by compressing data of the record with the compression unit 17. In a case of a compressed record that has been determined by the decompression determination unit 18, which is described below, to be a record to be decompressed, the diagnosis-and-treatment-information management unit 14 causes the decompression unit 19 to decompress the compressed record, thereby obtaining the original record.

Furthermore, on the basis of information (the diagnosis-and-treatment-record table, a hospital-attendance-record table regarding attendance of patients at a hospital, and so forth) stored in the diagnosis-and-treatment-information memory 11, the diagnosis-and-treatment-information management unit 14 may update the information stored in the diagnosis-and-treatment-record table. For example, in the case where T (true, i.e., completion) is stored as the completion flag in a record among the records included in the diagnosis-and-treatment-record table, the diagnosis-and-treatment-information management unit 14 may retrieve, in the diagnosis-and-treatment-record table, records in which the patient ID and the clinical department ID the same as those stored in the record in which T is stored as the completion flag are stored, and in which the completion flag is F (false, i.e., incompletion). Additionally, the diagnosis-and-treatment-information management unit 14 may update the completion flag to T (true) in the retrieved records, and may store, in the individual retrieved records, as the date of completion of diagnosis and treatment, information that is stored as the date of diagnosis and treatment in the record in which T (true) is first stored as the completion flag.

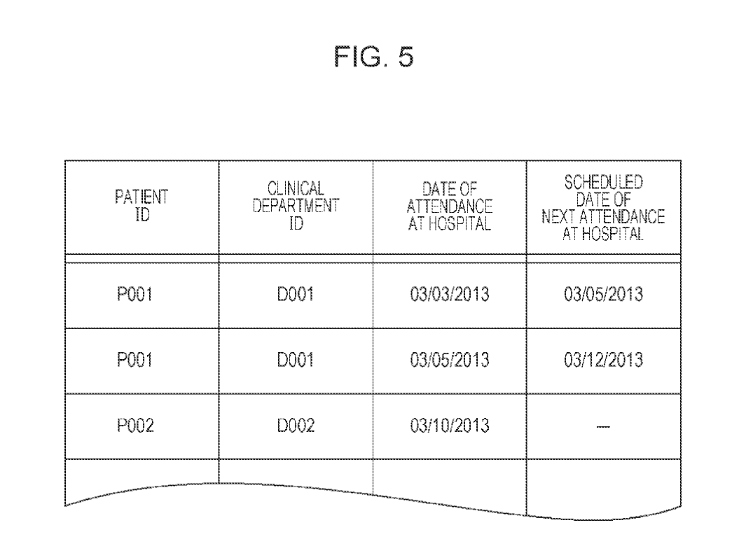

Here, an example of a process in the case of, on the basis of the diagnosis-and-treatment-record table, which is illustrated in FIG. 3, and the hospital-attendance-record table, which is illustrated in FIG. 5, determining whether or not diagnosis and treatment has been completed will be described.

The hospital-attendance-record table illustrated in FIG. 5 is an example of data as which records about attendance of each patient at the hospital are stored. As illustrated in FIG. 5, in the hospital-attendance-record table, the above-mentioned records are stored. In each of the records, information is stored. The information indicates the following: the patient ID; the clinical department ID; a date of attendance at the hospital; and a scheduled date of next attendance at the hospital. In each of the records, the patient ID, the clinical department ID, the date of attendance at the hospital, and the scheduled date of next attendance at the hospital are associated with one another. Note that the hospital-attendance-record table may be stored in the diagnosis-and-treatment-information memory 11, or may be stored in another database server.

The diagnosis-and-treatment-information management unit 14 retrieves, among the records recorded in the hospital-attendance-record table, a record in which no information is stored as the scheduled date of next attendance at the hospital. Moreover, the diagnosis-and-treatment-information management unit 14 determines whether, after the retrieved record, records in which the date of attendance at the hospital stored in the retrieved record or any date thereafter is stored as the date of attendance at the hospital, and in which the combination of the patient ID and the clinical department ID the same as that stored in the retrieved record is stored show up. In the case where such records show up after the retrieved record, the diagnosis-and-treatment-information management unit 14 retrieves, among the records, a record (a diagnosis-and-treatment completion record) in which a date that is a threshold (for example, five years) or more separated from the date of attendance at the hospital stored in the retrieved record is stored as the date of attendance at the hospital. Then, the diagnosis-and-treatment-information management unit 14 determines, among records in which the completion flag is F (false) among the records stored in the diagnosis-and-treatment-record table, a record in which the patient ID and the clinical department ID the same as those stored in the diagnosis-and-treatment completion record are stored, and in which the date of diagnosis and treatment is the same as (or only a predetermined number of days different from) the date of attendance at the hospital stored in the diagnosis-and-treatment completion record. The diagnosis-and-treatment-information management unit 14 may store T (true) as the completion flag in the determined record.

Furthermore, the diagnosis-and-treatment-information management unit 14 may, on the basis of information accepted from an input device, a client apparatus, or the like, add a record to the diagnosis-and-treatment-record table, or update information stored in any one of the records recorded in the diagnosis-and-treatment-record table.

The removal determination unit 15 determines whether or not each of the records included in the diagnosis-and-treatment-record table stored in the diagnosis-and-treatment-information memory 11 satisfies a removal condition. For example, in the case where, regarding a record among the records included in the diagnosis-and-treatment-record table, diagnosis and treatment for the disease stored in the record has been completed, where the disease (the disease ID) stored in the record is not a recurrent disease, and where a predetermined time period (for example, five years) has elapsed since the date of completion of diagnosis and treatment stored in the record, the removal determination unit 15 may determine that the record is to be removed, and may determine that the records other than the record are to not be removed.

The compression determination unit 16 determines whether or not each of the records included in the diagnosis-and-treatment-record table stored in the diagnosis-and-treatment-information memory 11 satisfies a compression condition. For example, in the case where, regarding a record among the records included in the diagnosis-and-treatment-record table, diagnosis and treatment for the disease stored in the record has been completed and where the disease (the disease ID) stored in the record is a recurrent disease, the compression determination unit 16 may determine that the record is to be compressed, and may determine that the records other than the record are to not be compressed. Furthermore, in the case where, regarding a record among the records included in the diagnosis-and-treatment-record table, diagnosis and treatment for the disease stored in the record has been completed, where the disease (the disease ID) stored in the record is a recurrent disease, and where a predetermined number of days have elapsed since the record was last accessed, the compression determination unit 16 may determine that the record is to be compressed. Note that whether or not diagnosis and treatment for the disease stored in a record has been completed may be determined by referring to the value of the completion flag stored in the record. Whether or not the disease stored in a record is a recurrent disease may be determined by referring to the value of the recurrence flag stored for the disease ID of the disease in the disease-information table.

The compression unit 17 compresses one portion of data of a record (a compression target record) which has been determined by the compression determination unit 16 to be a record to be compressed so that the amount of the data will be reduced. For example, the compression unit 17 may compress at least data regarding diagnosis and treatment details out of the data of the compression target record.

The diagnosis-and-treatment-information management unit 14 updates the compression target record using the data compressed by the compression unit 17, and resisters information concerning the compression target record in the compressed-information table. For example, the diagnosis-and-treatment-information management unit 14 may register, in the compressed-information table, a record in which the diagnosis and treatment record ID, the disease ID, the date of completion of diagnosis and treatment, and the date of compression of data stored in the compression target record are stored so as to be associated with one another.

The decompression determination unit 18 determines whether or not each of the records included in the compressed-information table stored in the compressed-information memory 12 satisfies a decompression condition. For example, for each of the records included in the compressed-information table, a time at which at least one of the recurrence interval and the recurrence time period that are stored in the disease-information table so as to be associated with the disease ID stored in the record will elapse from the date of completion of diagnosis and treatment stored in the record is calculated as a predicted recurrence time. In the case where, regarding a record among the records included in the compressed-information table, the number of remaining days (a remaining time period) from the current date and time to the predicted recurrence time for the record is within a threshold, the decompression determination unit 18 may determine that the record is to be decompressed, and may determine that the records other than the record are to not be decompressed.

The decompression unit 19 determines, on the basis of the diagnosis and treatment record ID stored in a record (a decompression target record) that has been determined by the decompression determination unit 18 to be a record to be decompressed, a target record in the diagnosis-and-treatment-record table, and decompresses the compressed data of the determined record, thereby obtaining data in the original format.

The recurrence analysis unit 20 analyzes, on the basis of the information recorded in the diagnosis-and-treatment-record table stored in the diagnosis-and-treatment-information memory 11, whether a disease is a recurrent disease. For example, in the case where a combination of the patient ID and the disease ID repeatedly shows up a predetermined number of times or more in the diagnosis-and-treatment-record table, the recurrence analysis unit 20 may determine that the disease ID indicates a recurrent disease. In this case, the recurrence analysis unit 20 may calculate, as the recurrence interval for the disease ID, for example, the average value of time intervals at which the combination of the patient ID and the disease ID repeatedly shows up, and may store information indicating the disease ID and the recurrence interval in the disease-information table.

Furthermore, the recurrence analysis unit 20 may calculate the frequency distribution of a disease development time period for a disease in the diagnosis-and-treatment-record table. In the case where the frequency of development of a disease differs depending on seasons (time periods), the recurrence analysis unit 20 may determine that the disease is a recurrent disease. In this case, the recurrence analysis unit 20 may determine a season in which the frequency of development of a disease is high as the disease development time period (the disease development season) for the disease, and may store information indicating the disease ID and the recurrence time period (the disease development season) in the disease-information table.

### 2. Description of Processes Performed by Diagnosis-and-Treatment-Record Management Apparatus 10

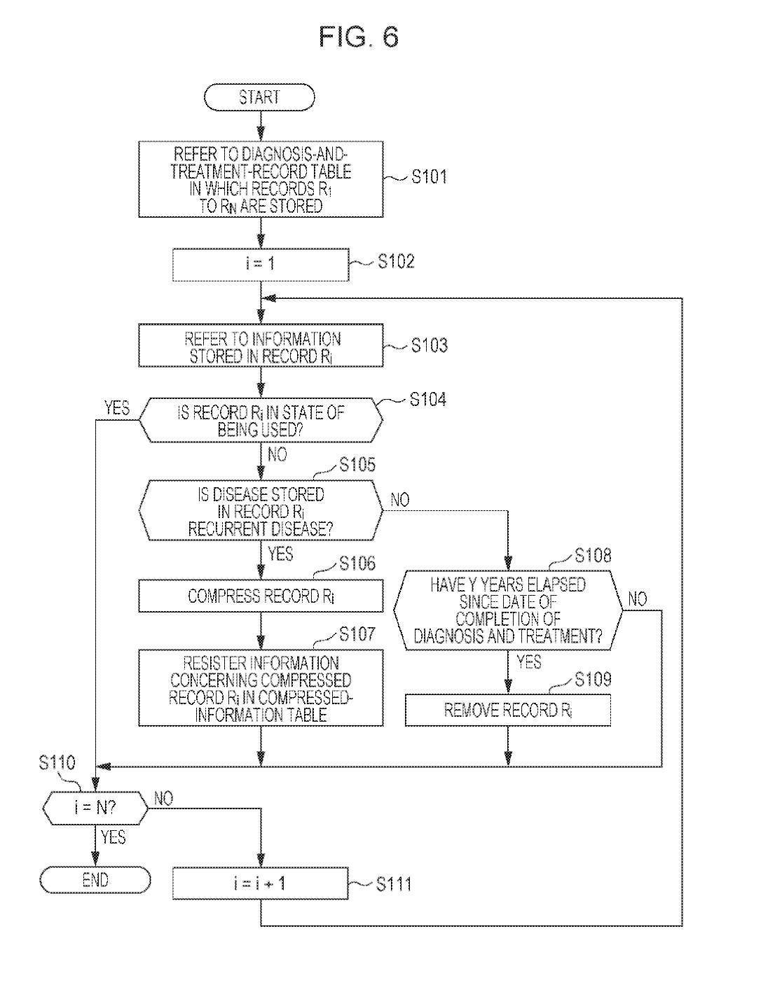

Next, the details of processes performed by the diagnosis-and-treatment-record management apparatus 10 will be described with reference to flowcharts of FIGS. 6 to 8.

### 2-1. Process of Compressing or Removing Record

First, with reference to FIG. 6, an example of a process, which is performed by the diagnosis-and-treatment-record management apparatus 10, of compressing or removing a record included in the diagnosis-and-treatment-record table will be described.

As illustrated in FIG. 6, the diagnosis-and-treatment-record management apparatus 10 refers to the diagnosis-and-treatment-record table in which records R₁ to R_{N} are stored (step S101), and initializes a variable i so that the variable i will be one (step S102).

Next, the diagnosis-and-treatment-record management apparatus 10 refers to information stored in the record Rᵢ (step S103), and determines whether or not the record Rᵢ is in a state of being used (step S104). For example, when the completion flag stored in the record Rᵢ is T (true) and a predetermined number of days have elapsed since the record Rᵢ was last accessed, the diagnosis-and-treatment-record management apparatus 10 may determine that the record Rᵢ is not in a state of being used, and, otherwise, may determine that the record Rᵢ is in a state of being used.

When the record Rᵢ is not in a state of being used (NO in step S104) and the disease (the disease ID) stored in the record Rᵢ is a recurrent disease (YES in step S105), the diagnosis-and-treatment-record management apparatus 10 compresses data of the record Rᵢ so that the amount of the data will be reduced (step S106), and registers information concerning the compressed record Rᵢ in the compressed-information table (step S107).

Furthermore, in the case where, in step S105, the disease (the disease ID) stored in the record Rᵢ is not a recurrent disease (NO in S105) and where Y years (for example, five years) have elapsed since the date of completion of diagnosis and treatment stored in the record Rᵢ (YES in step S108), the diagnosis-and-treatment-record management apparatus 10 removes the record Rᵢ (step S109).

In the case where, in step S104, the record Rᵢ is in a state of being used (YES in step S104), in the case after step S107, in the case after step S109, or in the case where, in step S108, Y years (for example, five years) have not elapsed since the date of completion of diagnosis and treatment stored in the record Rᵢ (NO in step S108), the diagnosis-and-treatment-record management apparatus 10 proceeds to step S110. Here, when the variable i has not reached N (NO in step S110), the diagnosis-and-treatment-record management apparatus 10 increments the variable i by one (adds one to the variable i) (step S111), and returns to step S103. When the variable i has reached N (YES in step S110), the diagnosis-and-treatment-record management apparatus 10 finishes the process.

The above-described process of compressing or removing a record may be performed when a predetermined event occurs, or may be performed at predetermined time intervals.

### 2-2. Process of Decompressing Record

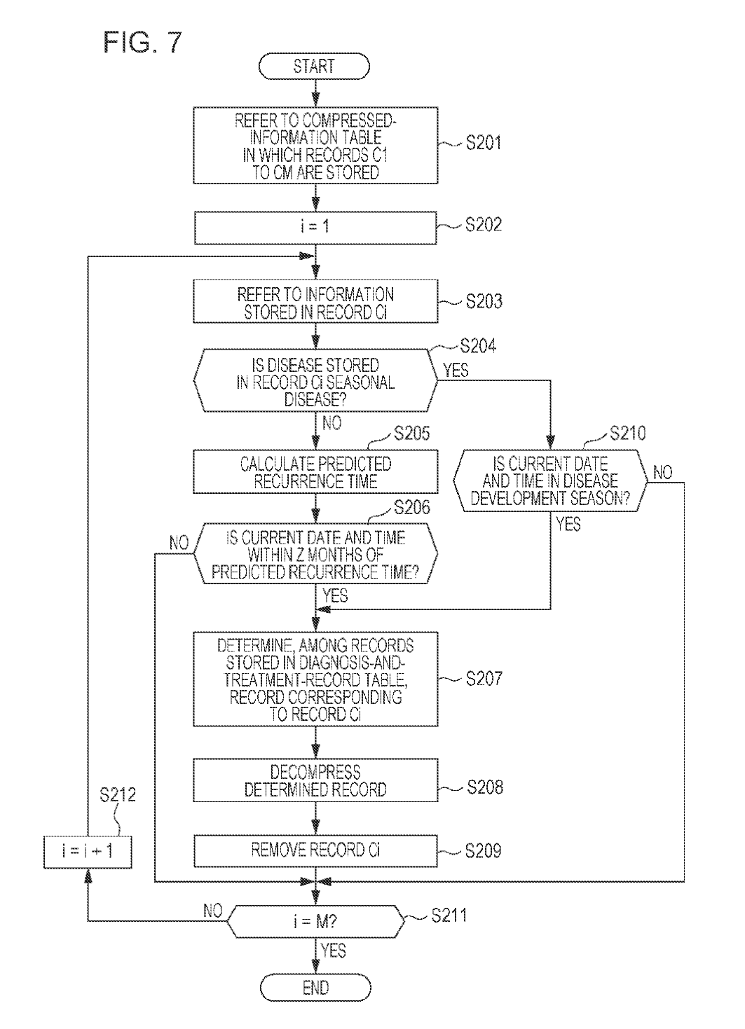

Next, an example of a process, which is performed by the diagnosis-and-treatment-record management apparatus 10, of decompressing a compressed record will be described with reference to FIG. 7.

As illustrated in FIG. 7, the diagnosis-and-treatment-record management apparatus 10 refers to the compressed-information table in which records C₁ to C_{M} are stored (step S201), and initializes a variable i so that the variable i will be one (step S202).

Next, the diagnosis-and-treatment-record management apparatus 10 refers to information stored in the record Cᵢ (step S203), and obtains the disease ID, the date of completion of diagnosis and treatment, and so forth for the record Cᵢ. In addition, the diagnosis-and-treatment-record management apparatus 10 obtains, from the disease-information table, on the basis of the obtained disease ID, the recurrence interval or the recurrence time period (the disease development season) for the disease (the disease ID) stored in the record Cᵢ.

When the disease stored in the record Cᵢ is not a seasonal disease (NO in step S204), the diagnosis-and-treatment-record management apparatus 10 calculates, as the predicted recurrence time, a time at which the recurrence interval will elapse from the date of completion of diagnosis and treatment for the record Cᵢ (step S205), and determines whether or not the current date and time is within Z months (for example, six months) of the predicted recurrence time (step S206).

Here, when, in step S206, the current date and time is within Z months (for example, six months) of the predicted recurrence time (YES in step S206), the diagnosis-and-treatment-record management apparatus 10 determines, on the basis of the diagnosis and treatment record ID stored in the record Cᵢ, among the records included in the diagnosis-and-treatment-record table, a record corresponding to the record Cᵢ (step S207), and decompresses compressed data of the determined record (step S208). When the diagnosis-and-treatment-record management apparatus 10 has decompressed the record that corresponds to the record Cᵢ and that is stored in the diagnosis-and-treatment-record table, the diagnosis-and-treatment-record management apparatus 10 may remove the record Cᵢ (step S209).

Furthermore, when, in step S204, the disease stored in the record Cᵢ is a seasonal disease (YES in step S204) and, then, when the current date and time is in the disease development season for the record Cᵢ (YES in step S210), the diagnosis-and-treatment-record management apparatus 10 proceeds to step S207.

In a case where, in step S206, the current date and time is not within Z months (for example, six months) of the predicted recurrence time (NO in step S206), in the case after step S209, or in the case where, in step S210, the current date and time is not in the disease development season for the record Cᵢ (NO in step S210), the diagnosis-and-treatment-record management apparatus 10 proceeds to step S211. Here, when the variable i has not reached M (NO in step S211), the diagnosis-and-treatment-record management apparatus 10 increments the variable i by one (adds one to the variable i) (step S212), and returns to step S203. When the variable i has reached M (YES in step S211), the diagnosis-and-treatment-record management apparatus 10 finishes the process.

The above-described process of decompressing a record may be performed when a predetermined event occurs, or may be performed at predetermined time intervals.

### 2-3. Process of Analyzing Recurrence of Disease

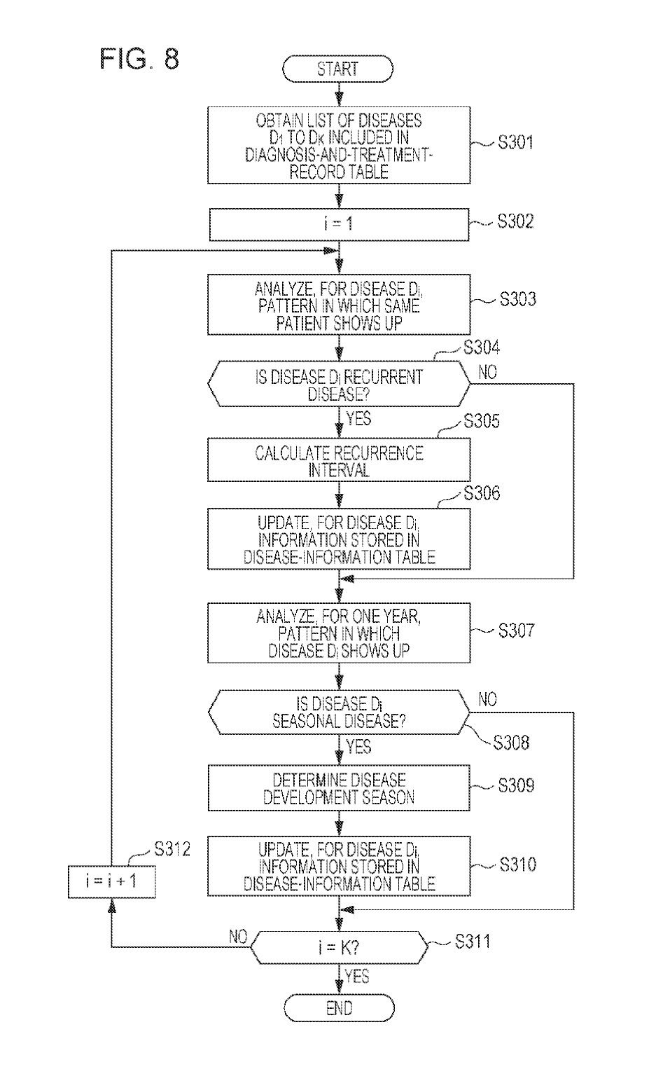

Next, an example of a process, which is performed by the diagnosis-and-treatment-record management apparatus 10, of analyzing recurrence of a disease will be described with reference to FIG. 8.

As illustrated in FIG. 8, the diagnosis-and-treatment-record management apparatus 10 obtains a list of diseases D₁ to D_{K} included in the diagnosis-and-treatment-record table (step S301), and initializes a variable i so that the variable i will be one (step S302).

Next, the diagnosis-and-treatment-record management apparatus 10 analyzes, for the disease Dᵢ, a pattern in which the same patient shows up (step S303). When the same patient shows up multiple times, the diagnosis-and-treatment-record management apparatus 10 determines that the disease Dᵢ is a recurrent disease (YES in step S304), and calculates the recurrence interval on the basis of the pattern in which the same patient shows up (step S305). Then, the diagnosis-and-treatment-record management apparatus 10 registers, for the disease Dᵢ, information indicating the recurrence flag and the recurrence interval so that the recurrence flag and the recurrence interval are associated with the disease Dᵢ, thereby updating the information stored in the disease-information table (step S306).

In the case after step S306 or in the case where, in step S304, the disease Dᵢ is not a recurrent disease (NO in step S304), the diagnosis-and-treatment-record management apparatus 10 analyzes, for a predetermined time period (for example, for one year), a pattern in which the disease Dᵢ shows up (step S307). When the frequency of development of the disease Dᵢ differs depending on seasons, the diagnosis-and-treatment-record management apparatus 10 determines that the disease Dᵢ is a seasonal disease (YES in step S308), and determines a season in which the frequency of development of the disease Dᵢ is high as the disease development season (step S309). Then, the diagnosis-and-treatment-record management apparatus 10 registers, for the disease Dᵢ, information indicating the recurrence flag and the recurrence time period (the disease development season) so that the recurrence flag and the recurrence time period are associated with the disease Dᵢ, thereby updating the information stored in the disease-information table (step S310).

In the case after step S310 or in the case where, in step S308, the disease Dᵢ is not a seasonal disease (NO in step S308), the diagnosis-and-treatment-record management apparatus 10 proceeds to step S311. Here, when the variable i has not reached K (NO in step S311), the diagnosis-and-treatment-record management apparatus 10 increments the variable i by one (adds one to the variable i) (step S312), and returns to step S303. When the variable i has reached K (YES in step S311), the diagnosis-and-treatment-record management apparatus 10 finishes the process.

The above-described process of analyzing recurrence of a disease may be performed when a predetermined event occurs, or may be performed at predetermined time intervals.

In the diagnosis-and-treatment-record management apparatus 10 according to the present exemplary embodiment described above, data of a diagnosis and treatment record that concerns a recurrent disease and that is not in a state of being used is compressed and stored, thereby making it possible to reduce the amount of the data. Additionally, the data is decompressed in accordance with the recurrence time period, thereby making it possible to prevent a diagnosis and treatment record that is necessary from being inaccessible.

The present invention is not limited to the foregoing exemplary embodiment. For example, the disease-information table may be provided in advance. Furthermore, in the present exemplary embodiment, an example is described, in which the diagnosis-and-treatment-record management apparatus 10 holds databases such as the diagnosis-and-treatment-information memory 11, the compressed-information memory 12, and the disease-information memory 13. However, a database server different from the diagnosis-and-treatment-record management apparatus 10 may hold these databases, and the diagnosis-and-treatment-record management apparatus 10 may access the database server and use information stored in the databases.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A diagnosis-and-treatment-record management system comprising:
a diagnosis-and-treatment-information memory that stores one or more records, each of the records being a record in which patient identification information by which a patient is identified and diagnosis and treatment details for a disease of the patient are recorded;
a disease-information memory that stores information indicating at least one of a recurrence interval and a recurrence time period for a recurrent disease, the recurrent disease recurring at the recurrence intervals, the recurrent disease recurring for the recurrence time period;
a compression unit that compresses information recorded in, among the records stored in the diagnosis-and-treatment-information memory, a record the use of which for consultation has been at least temporarily completed and in which diagnosis and treatment details for a recurrent disease are recorded; and
a decompression unit that, since a reference time at which treatment for the disease associated with the diagnosis details recorded in the record for which information recorded therein has been compressed by the compression unit was completed, before at least one of the recurrence interval and the recurrence time period which are stored for the disease in the disease-information memory has elapsed, decompresses the compressed information for the record.

2. The diagnosis-and-treatment-record management system according to claim 1, further comprising a removal unit that removes, among the records stored in the diagnosis-and-treatment-information memory, a record in which diagnosis and treatment details for a disease that is not a recurrent disease are recorded and for which at least a predetermined time period has elapsed since a reference time at which the use of the record for the disease associated with the diagnosis details recorded in the record was completed.

3. The diagnosis-and-treatment-record management system according to claim 1, further comprising:
a first determination unit that, on the basis of whether or not a combination of the patient identification information and a disease which are recorded in the records stored in the diagnosis-and-treatment-information memory repeatedly shows up, determines whether or not the disease is a recurrent disease;
a first decision unit that, on the basis of intervals at which the disease determined by the first determination unit to be a recurrent disease shows up, decides the recurrence interval for the disease; and
a unit that causes the disease-information memory to store, for the disease which has been determined by the first determination unit to be a recurrent disease, the recurrence interval, which has been decided by the first decision unit, so that the recurrence interval is associated with the disease.

4. The diagnosis-and-treatment-record management system according to claim 2, further comprising:
a first determination unit that, on the basis of whether or not a combination of the patient identification information and a disease which are recorded in the records stored in the diagnosis-and-treatment-information memory repeatedly shows up, determines whether or not the disease is a recurrent disease;
a first decision unit that, on the basis of intervals at which the disease determined by the first determination unit to be a recurrent disease shows up, decides the recurrence interval for the disease; and
a unit that causes the disease-information memory to store, for the disease which has been determined by the first determination unit to be a recurrent disease, the recurrence interval, which has been decided by the first decision unit, so that the recurrence interval is associated with the disease.

5. The diagnosis-and-treatment-record management system according to claim 1, further comprising:
a second determination unit that, on the basis of whether or not development of a disease which is recorded in the records stored in the diagnosis-and-treatment-information memory differs depending on seasons, determines whether or not the disease is a recurrent disease;
a second decision unit that, on the basis of a season in which the frequency of development of the disease that has been determined by the second determination unit to be a recurrent disease is high, decides the recurrence time period for the disease; and
a unit that causes the disease-information memory to store, for the disease which has been determined by the second determination unit to be a recurrent disease, the recurrence time period, which has been decided by the second decision unit, so that the recurrence time period is associated with the disease.

6. The diagnosis-and-treatment-record management system according to claim 2, further comprising:
a second determination unit that, on the basis of whether or not development of a disease which is recorded in the records stored in the diagnosis-and-treatment-information memory differs depending on seasons, determines whether or not the disease is a recurrent disease;
a second decision unit that, on the basis of a season in which the frequency of development of the disease that has been determined by the second determination unit to be a recurrent disease is high, decides the recurrence time period for the disease; and
a unit that causes the disease-information memory to store, for the disease which has been determined by the second determination unit to be a recurrent disease, the recurrence time period, which has been decided by the second decision unit, so that the recurrence time period is associated with the disease.

7. The diagnosis-and-treatment-record management system according to claim 3, further comprising:
a second determination unit that, on the basis of whether or not development of a disease which is recorded in the records stored in the diagnosis-and-treatment-information memory differs depending on seasons, determines whether or not the disease is a recurrent disease;
a second decision unit that, on the basis of a season in which the frequency of development of the disease that has been determined by the second determination unit to be a recurrent disease is high, decides the recurrence time period for the disease; and
a unit that causes the disease-information memory to store, for the disease which has been determined by the second determination unit to be a recurrent disease, the recurrence time period, which has been decided by the second decision unit, so that the recurrence time period is associated with the disease.

8. The diagnosis-and-treatment-record management system according to claim 4, further comprising:
a second determination unit that, on the basis of whether or not development of a disease which is recorded in the records stored in the diagnosis-and-treatment-information memory differs depending on seasons, determines whether or not the disease is a recurrent disease;
a second decision unit that, on the basis of a season in which the frequency of development of the disease that has been determined by the second determination unit to be a recurrent disease is high, decides the recurrence time period for the disease; and
a unit that causes the disease-information memory to store, for the disease which has been determined by the second determination unit to be a recurrent disease, the recurrence time period, which has been decided by the second decision unit, so that the recurrence time period is associated with the disease.

9. A diagnosis-and-treatment-record management method comprising:
storing one or more records, each of the records being a record in which patient identification information by which a patient is identified and diagnosis and treatment details for a disease of the patient are recorded;
storing information indicating at least one of a recurrence interval and a recurrence time period for a recurrent disease, the recurrent disease recurring at the recurrence intervals, the recurrent disease recurring for the recurrence time period;
compressing information recorded in, among the stored records, a record the use of which for consultation has been at least temporarily completed and in which diagnosis and treatment details for a recurrent disease are recorded; and
decompressing, since a reference time at which treatment for the disease associated with the diagnosis details recorded in the record for which information recorded therein has been compressed was completed, before at least one of the recurrence interval and the recurrence time period which are stored for the disease has elapsed, the compressed information for the record.

10. A non-transitory computer-readable medium storing a program causing a computer to execute a process, the process comprising:
storing one or more records, each of the records being a record in which patient identification information by which a patient is identified and diagnosis and treatment details for a disease of the patient are recorded;
storing information indicating at least one of a recurrence interval and a recurrence time period for a recurrent disease, the recurrent disease recurring at the recurrence intervals, the recurrent disease recurring for the recurrence time period;
compressing information recorded in, among the stored records, a record the use of which for consultation has been at least temporarily completed and in which diagnosis and treatment details for a recurrent disease are recorded; and
decompressing, since a reference time at which treatment for the disease associated with the diagnosis details recorded in the record for which information recorded therein has been compressed was completed, before at least one of the recurrence interval and the recurrence time period which are stored for the disease has elapsed, the compressed information for the record.
